(19) United States
(12) Patent Application Publication
(10) Pub. No.: US 2012/0258270 A1
(43) Pub. Date: Oct. 11, 2012

(54) METHOD FOR EXTRUDING POLYMER

(75) Inventor: Dane Chang, Sugar Land, TX (US)

(73) Assignee: Dow Global Technologies LLC, Midland, MI (US)

(21) Appl. No.: 13/515,666

(22) PCT Filed: Dec. 30, 2010
(86) PCT No.: PCT/US10/62486

§ 371 Date: Jun. 13, 2012

Related U.S. Application Data
(60) Provisional application No. 61/291,407, filed on Dec. 31, 2009.
(60) Provisional application No. 61/291,250, filed on Dec. 30, 2009.

(51) Int. Cl. B29C 47/94; B32B 1/08; C08K 5/07

(52) U.S. Cl. 428/36.92; 524/361; 264/39

(57) ABSTRACT

The invention provides a process for extruding a composition, comprising at least one polymer, through a die, comprising applying at least one processing additive (PA) onto at least one surface of the die, and extruding the composition through the die, and wherein the processing additive is applied to the die as a solution. The invention also provides a composition comprising at least one processing additive (PA), and a solvent or a solvent mixture.

### CROSS-REFERENCE TO RELATED APPLICATIONS

This application claims the benefit of U.S. Provisional Patent Application No. 61/291,250, filed on Dec. 30, 2009, and U.S. Provisional Patent Application No. 61/291,407, filed on Dec. 31, 2009; each application is fully incorporated herein by reference.

### BACKGROUND OF THE INVENTION

Pipe resins made with polymers having high molecular weight yield pipes with high performance properties. However, extrusion issues (for example, melt fracture/rough surface appearance, low pipe output rates, etc.) often cause concerns for pipe manufacturers. The extent of each issue varies, depending on the tooling used (for example, die design, age of equipment, extruder conditions, etc.). Sometimes, a pipe manufacturer may produce scrap pipe (for example, unacceptable pipe due to a poor surface appearance) for hours, or even days, before extruding acceptable pipes that only barely meet minimum standards. The scrap pipes need to be reground and recycled, which require additional costs and additional resource. Various materials for extruder purging and die conditioning have been tried with limited successes. There is a need for a fast, effective and less expensive solution to significantly reduce the amount of scrap generated during start up of a pipe extrusion, and reduce the time needed before acceptable pipe is produced.

International Publication No. WO 2004/076151 discloses a process and apparatus for substantially eliminating surface melt fracture during the extrusion of a thermoplastic polymer, such as a linear low density, by using a die having an elastic coating on its inner surface adjacent to the die exit. The process comprises the steps of heating the thermoplastic polymer above the temperature of melting, and extruding the molten polymer through a die gap. The die has a die land region defining opposing surfaces, and the thermoplastic polymer has a surface in contact with the opposing surfaces. At least one of the opposing surfaces, in an area adjacent to the die orifice, is coated with an elastic material. This reference discloses a polymerized rubber coating or a rubber ring in the die design.

U.S. Publication No. 2008/0308967 discloses an extrusion of polyolefin resins, especially polyethylene resin, with a disclosed increase rate of defect free extrusion. Molten thermoplastic polymeric material, comprising additives of elastomers and an elastic layer, substantially coats at least a portion of the die cavity inner wall, adjacent to the die exit, during extrusion. A composition of thermoplastic polymeric material comprises polyolefins and elastomers, and the elastomers are selected from thermoplastic elastomers based on block copolymers or raw rubbers which cure in situ at the die inner wall. In a particular embodiment, a die inner wall has catalytic activity to appropriate rubber vulcanization.

International Publication No. WO 2007/053051 discloses a method of processing thermoplastic polymeric material (thermoplast) through an extrusion die, which entails coating of the die wall with a layer of a viscoelastic substance, such as a silanol or a polyol cured by a borate. The thermoplast may comprise a processing additive, such as a silanol or a polyol, in combination with a curing agent, such as a borate, or it may comprise a silanol or a polyol cured by a borate. The reaction between the silanol and polyol with the curing agent may be effected in the presence of a catalyst, such as a phosphate. However, the coating of the die wall with a layer of viscoelastic substance is a slow process, and dependent of rate of reaction between thermoplast and the curing agent.

Fluoropolymer processing additives for HDPE pipe formulations are discussed in the following references: Amos et al., Benefits of Using Fluoropolymer Based Polymer Processing Additives in HDPE Pipe Formulations, a Dynamar publication, 2001; Papp et al., DYNAMAR Fluoropolymer Processing Additives (PPAs) in Applications of HDPE Pipes, a Dynamar publication, 2001.

Process additives of various resins have been developed for, and used on, many plastics application with various degrees of successes, depending on the process conditions and tooling design. Typically, for pipe extrusion, conditions are lean toward the low shear side, especially for some larger diameter pipes, where the shear rate can be as low as 10 sec⁻¹ or less. Under these low shear conditions, the amount of time required for a process additive in the resin to effectively coat the die gap completely, is very long, and sometimes can be days. Typically, pipe producers set up tooling to produce various pipe sizes based on their customer orders. Occasionally, the tooling needs to be changed daily to meet the small orders. Producers want the pipe to look good, as soon as possible, not waiting hours or days to collect small amounts of pipes. Doping of high concentration of a process additive in the pipe resin at start up, to quickly condition the die can be effective sometimes, however, the drawback is the die drool build up, which can typically cause unforeseen premature failures, such as in ductile mode and/or brittle mode.

Extrusion processes of the art are complicated, involving multiple steps, and sometimes curing reactions. Some processes require a significant time for a process additive in a resin to form a complete coating on an extrusion die. Until the die is fully coated/conditioned with the process additive, melt fracture and die lines can not be eliminated. When the melt fracture and die lines exist, the articles produced, are usually consider scrap that need to be recycled. Depending on the die design and age, the time required for the die to be fully conditioned may take hours or days, which makes these conventional processes very costly, as hundreds and even thousands pounds of material need to be recycled. As discussed above, there is a need for a fast, effective and less expensive solution to significantly reduce the amount of scrap generated during start up of a pipe extrusion. There is a further need for such a solution to be applied easily and rapidly, with a minimal delay, before extruding acceptable polymer. These needs have been met by the following invention.

### SUMMARY OF THE INVENTION

The invention provides process for a process for extruding a composition, comprising at least one polymer, through a die, comprising applying at least one processing additive (PA) onto at least one surface of the die, and extruding the composition through the die, and wherein the processing additive is applied to the die as a solution.

The invention also provides a composition comprising at least one processing additive (PA), and a solvent or a solvent mixture.

### DETAILED DESCRIPTION OF THE INVENTION

To avoid a long waiting period for small amounts of a process additive in the resin to slowly coat/cover the entire die gap (which may take hours or days of scrap generation), or long waits associated with other die coating applications, as discussed above, it has been discovered that a direct application (for example, a “spray on” or “brush on”) of an additive solution (for example, 5-30 wt % of a processing additive in a solvent) on to the die, and preferably onto the die gap, to pre-condition the die gap before the extrusion, is very successful and effective for a fast pipe extrusion “start-up,” eliminating hundreds, and sometimes thousands, of pounds of pipe scrap. It has been discovered that this process takes only minutes to do, and results in the extrusion of pipes with good surface appearance at start up, even when old, worn tooling was used in the extrusion process.

As discussed above, the invention provides a process for extruding a composition, comprising at least one polymer, through a die, comprising applying at least one processing additive (PA) onto at least one surface of the die, and preferably onto at least one surface of the die gap (the metal faces forming the die opening), and then extruding the composition through the die, and wherein the processing additive is applied to the die as a solution. A solution comprises at least one processing additive (PA) and at least one solvent. The processing additive may be dissolved or partially dissolved in a solution.

In one embodiment, the processing additive is dissolved in a solvent or a solvent mixture (two or more solvents).

In one embodiment, the processing additive is partially dissolved in a solvent or solvent mixture.

In one embodiment, the processing additive is dissolved in a solvent that has a maximum boiling point less than 100° C., preferably less than 90° C., and more preferably less than 80° C., and even more preferably 70° C. (at ambient atmosphere).

In one embodiment, the processing additive is dissolved in a solvent or solvent mixture that has a maximum boiling point less than 100° C., preferably less than 90° C., and more preferably less than 80° C., and even more preferably 70° C. (at ambient atmosphere).

In one embodiment, the processing additive is dissolved in a solvent mixture that has a maximum boiling point less than 100° C., preferably less than 90° C., and more preferably less than 80° C., and even more preferably 70° C. (at ambient atmosphere).

In one embodiment, the solution containing the processing additive is sprayed onto the die surface, and preferably the surface of the die gap.

In one embodiment, the solution containing the processing additive is brushed onto the die surface, and preferably the surface of the die gap.

In one embodiment, the composition is extruded through the die in less than 10 minutes, preferably less than 5 minutes, and more preferably less than 3 minute, after the processing additive is applied to the die, and preferably the die gap.

In one embodiment, the composition is extruded through the die in less than 3 minutes, preferably less than 2 minutes, and more preferably less than 1 minute, after the processing additive is applied to the die, and preferably the die gap.

In one embodiment, the processing additive is dissolved in a solvent at a concentration of 50 weight percent or less, based on the weight of the solution.

In one embodiment, the processing additive is dissolved in a solvent or solvent mixture at a concentration of 50 weight percent or less, based on the weight of the solution.

In one embodiment, the processing additive is dissolved in a solvent mixture at a concentration of 50 weight percent or less, based on the weight of the solution.

In one embodiment, the processing additive is dissolved in a solvent at a concentration of 30 weight percent or less, based on the weight of the solution.

In one embodiment, the processing additive is dissolved in a solvent or solvent mixture at a concentration of 30 weight percent or less, based on the weight of the solution.

In one embodiment, the processing additive is dissolved in a solvent mixture at a concentration of 30 weight percent or less, based on the weight of the solution.

In one embodiment, the processing additive is dissolved in a solvent at a concentration from 1 to 50 weight percent, preferably from 5 to 30 weight percent, more preferably from 8 to 20 weight percent, based on the weight of the solution.

In one embodiment, the processing additive is dissolved in a solvent or solvent mixture at a concentration from 1 to 50 weight percent, preferably from 5 to 30 weight percent, more preferably from 8 to 20 weight percent, based on the weight of the solution.

In one embodiment, the processing additive is dissolved in a solvent mixture at a concentration from 1 to 50 weight percent, preferably from 5 to 30 weight percent, more preferably from 8 to 20 weight percent, based on the weight of the solution.

In one embodiment, the processing additive is dissolved in a solvent at a concentration from 5 to 25 weight percent, preferably from 10 to 15 weight percent, based on the weight of the solution.

In one embodiment, the processing additive is dissolved in a solvent or solvent mixture at a concentration from 5 to 25 weight percent, preferably from 10 to 15 weight percent, based on the weight of the solution.

In one embodiment, the processing additive is dissolved in a solvent mixture at a concentration from 5 to 25 weight percent, preferably from 10 to 15 weight percent, based on the weight of the solution.

In one embodiment, the solvent is selected from acetone, methyl ethyl ketone, isopropyl alcohol, or combinations thereof.

In one embodiment, the processing additive is selected from a fluoropolymer, a polyethylene glycol, or a combination thereof.

In one embodiment, the processing additive is a fluoropolymer (polymer that comprises one or more fluoro groups). In a further embodiment, the fluoropolymer is selected from fluorinated hydrocarbons or fluorosilicones.

Examples of fluoropolymers include, but are not limited to, polytetrafluoroethylene (PTFE), perfluoroalkoxy polymer (PFA), fluorinated ethylene-propylene (FEP), polyethylenetetrafluoroethylene (ETFE), polyvinylfluoride (PVF), polyethylenechlorotrifluoroethylene (ECTFE), polyvinylidene fluoride (PVDF), polychlorotrifluoroethylene (PCTFE), and perfluoropolyether (PFPE).

Some examples of commercial fluoropolymers include the following: TEFLON (available from of DuPont), HYFLON (available from Solvay Solexis S.p.A.), TEFZEL (available from DuPont), FLUON (available from Asahi Glass Company), TEDLAR (available from of DuPont), HALAR (available from Solvay Solexis S.p.A.), KYNAR (available from Arkema, Inc.), SOLEF (available from Solvay Solexis S.p.A.), HYLAR (available from Solvay Solexis S.p.A.), KALREZ (available from of DuPont), TECNOFLON (available from Solvay Solexis S.p.A.), VITON (available from of DuPont), FOMBLIN (available from Solvay Solexis S.p.A.), GALDEN (available from Solvay Solexis S.p.A.), and DYNAMAR (available from Dyneon).

In one embodiment, the processing additive is a polyethylene glycol. In a further embodiment, the polyethylene glycol has a number average molecular weight less than 20,000 g/mole. In another embodiment, the polyethylene glycol has a number average molecular weight from 300 to 100,000 g/mole.

In one embodiment, the polyethylene glycol is selected from linear polyethylene glycols, branched polyethylene glycols, star polyethylene glycols, comb polyethylene glycols, or combinations thereof.

Some commercial examples of polyethylene glycols include the following: CARBOWAX polyethylene glycols (available from The Dow Chemical Company), FORTRANS (available from Beaufour Ipsen Pharma), and MACROGOL (available from Sanyo Chemical Industries).

In one embodiment, the polymer is selected from the group consisting of olefin-based polymers, polyesters, polycarbonates, polyamides, polyurethanes, or mixtures thereof.

In one embodiment, the polymer is selected from the group consisting of LDPE (low density polyethylene), HDPE (high density polyethylene, LLDPE (linear low density polyethylene), EPDM, EVA (ethylene vinyl acetate), EEA (ethylene ethylacrylate, EAA (ethylene acrylic acid), EPR (ethylene/propylene rubber), polypropylene homopolymer, propylene/ethylene copolymers, and mixtures thereof.

In one embodiment, the polymer is an olefin-based polymer.

In one embodiment, the olefin-based polymer is an ethylene-based polymer. In a further embodiment, the ethylene-based polymer has a high load melt index (121) from 1 to 100 g/10 min, preferably from 1 to 50 g/10 min, preferably from 2 to 20 g/10 min, and more preferably from 4 to 10 g/10 min.

In one embodiment, the ethylene-based polymer has a number average molecular weight (Mn) from 100,000 to 1,000,000 g/mole, preferably 150,000 to 600,000 g/mole, and more preferably 200,000 to 400,000 g/mole.

In one embodiment, the olefin-based polymer is a propylene-based polymer. In a further embodiment, the propylene-based polymer has a melt flow rate (MFR) from 0.1 to 100 g/10 min, preferably from 0.15 to 50 g/10 min, and more preferably from 0.2 to 20 g/10 min.

In one embodiment, the propylene-based polymer has a number average molecular weight (Mn) from 100,000 to 1,000,000 g/mole, preferably 150,000 to 600,000 g/mole, and more preferably 200,000 to 400,000 g/mole.

In one embodiment, the propylene-based polymer is a propylene/ethylene interpolymer, and preferably a propylene/ethylene copolymer.

In one embodiment, the propylene-based polymer is a propylene/α-olefin interpolymer, and preferably a propylene/α-olefin copolymer. The α-olefins include, but are not limited to, 1-butene, 1-hexene and 1-octene.

Suitable propylene-based polymers include, but are not limited to, polypropylene homopolymers and impact-modified polypropylenes.

A polymer may comprise a combination of two or more embodiments as described herein.

An olefin-based polymer may comprise a combination of two or more embodiments as described herein.

An ethylene-based polymer may comprise a combination of two or more embodiments as described herein.

A propylene-based polymer may comprise a combination of two or more embodiments as described herein.

The inventive process can be used in any extrusion process or molding process that has melt fracture, die lines, and product appearance issues.

In one embodiment, up to 1 to 50 weight percent, preferably from 5 to 30 weight percent of the processing additive is dissolved in a high volatility solvent, to form a “PA solution.” In a further embodiment, this PA solution is applied directly onto the die, and preferably onto the die gap, by methods (e.g., “spray on” or “brushed on,” etc.) known by those skills of art, either before the die assembly is installed, or while the die assembly is in place, but before the extrusion process begins. The solvent evaporates quickly, and leaves full coverage of process additive on the die, preferably the die gap.

In one embodiment, the processing additive is dissolved in a solvent by stirring, agitating, or any other technique known in the art.

A solution containing the processing additive can be applied directly onto the die, preferably the die gap, evenly by brushing and/or through spraying, or any other practical techniques. The temperature of the die is preferably, but not limited to, room temperature. Depending on the technique employed, the process additive solution can be applied once, or multiple times, to ensure complete coverage of the die, preferably the die gap. Preferred environment for applying the process additive solution is in a well ventilated area.

It was discovered that the inventive process provided an instant coating of the processing additive on the die, which maintained its effectiveness, with very minimal scrap generated. In addition, it was discovered that the instant coating maintained its effectiveness during the critical “start-up” period of a pipe extrusion, which otherwise would take hours or days to achieve a pipe with smooth and shining outer and inner surfaces.

An inventive process may comprise a combination of two or more embodiments as described herein.

The invention also provides an article comprising at least one component formed from an inventive process.

In one embodiment, the article is a pipe.

In one embodiment, the article is a molded part.

In one embodiment, the article is a blow molded container.

In one embodiment, the article is an injection molded part.

In one embodiment, the article is a sheet.

In one embodiment, the article is a blown film.

An inventive article may comprise a combination of two or more embodiments as described herein.

The invention also provides a composition comprising at least one processing additive (PA), and a solvent or a solvent mixture.

In one embodiment, the composition comprises the processing additive and the solvent.

In one embodiment, the composition comprises the processing additive and the solvent mixture (two or more solvents).

In one embodiment, the processing additive is dissolved in the solvent or the solvent mixture.

In one embodiment, the processing additive is dissolved in the solvent.

In one embodiment, the processing additive is dissolved in the solvent mixture.

In one embodiment, the processing additive is partially dissolved in the solvent or the solvent mixture.

In one embodiment, the processing additive is partially dissolved in the solvent.

In one embodiment, the processing additive is partially dissolved in the solvent mixture.

In one embodiment, the solvent or solvent mixture has a maximum boiling point less than 100° C., preferably less than 90° C., and more preferably less than 80° C., and even more preferably 70° C. (at ambient atmosphere).

In one embodiment, the solvent has a maximum boiling point less than 100° C., preferably less than 90° C., and more preferably less than 80° C., and even more preferably 70° C. (at ambient atmosphere).

In one embodiment, the solvent mixture has a maximum boiling point less than 100° C., preferably less than 90° C., and more preferably less than 80° C., and even more preferably 70° C. (at ambient atmosphere).

In one embodiment, the processing additive is dissolved in the solvent, to form a solution, at a concentration of 50 weight percent or less, based on the weight of the solution. The solution comprises the processing additive and the solvent.

In one embodiment, the processing additive is dissolved in the solvent mixture, to form a solution, at a concentration of 50 weight percent or less, based on the weight of the solution. The solution comprises the processing additive and the solvent mixture.

In one embodiment, the processing additive is dissolved in the solvent or the solvent mixture, to form a solution, at a concentration of 50 weight percent or less, based on the weight of the solution.

In one embodiment, the processing additive is dissolved in the solvent, to form a solution, at a concentration of 30 weight percent or less, based on the weight of the solution.

In one embodiment, the processing additive is dissolved in the solvent mixture, to form a solution, at a concentration of 30 weight percent or less, based on the weight of the solution.

In one embodiment, the processing additive is dissolved in the solvent or the solvent mixture, to form a solution, at a concentration of 30 weight percent or less, based on the weight of the solution.

In one embodiment, the processing additive is dissolved in the solvent, to form a solution, at a concentration from 1 to 50 weight percent, preferably from 5 to 30 weight percent, more preferably from 8 to 20 weight percent, based on the weight of the solution.

In one embodiment, the processing additive is dissolved in a solvent mixture, to form a solution, at a concentration from 1 to 50 weight percent, preferably from 5 to 30 weight percent, more preferably from 8 to 20 weight percent, based on the weight of the solution.

In one embodiment, the processing additive is dissolved in the solvent or the solvent mixture, to form a solution, at a concentration from 1 to 50 weight percent, preferably from 5 to 30 weight percent, more preferably from 8 to 20 weight percent, based on the weight of the solution.

In one embodiment, the processing additive is dissolved in the solvent, to form a solution, at a concentration from 5 to 25 weight percent, preferably from 10 to 15 weight percent, based on the weight of the solution.

In one embodiment, the processing additive is dissolved in the solvent mixture, to form a solution, at a concentration from 5 to 25 weight percent, preferably from 10 to 15 weight percent, based on the weight of the solution.

In one embodiment, the processing additive is dissolved in the solvent or the solvent mixture, to form a solution, at a concentration from 5 to 25 weight percent, preferably from 10 to 15 weight percent, based on the weight of the solution.

In one embodiment, the solvent is selected from acetone, methyl ethyl ketone, or isopropyl alcohol.

In one embodiment, the solvent mixture comprises at least one solvent selected from acetone, methyl ethyl ketone, or isopropyl alcohol.

In one embodiment, the solvent is selected from acetone, methyl ethyl ketone, or isopropyl alcohol; or the solvent mixture comprises at least one solvent selected from acetone, methyl ethyl ketone, or isopropyl alcohol.

In one embodiment, the processing additive is selected from a fluoropolymer, a polyethylene glycol, or a combination thereof.

In one embodiment, the processing additive is a fluoropolymer (polymer that comprises one or more fluoro groups). In a further embodiment, the fluoropolymer is selected from fluorinated hydrocarbons or fluorosilicones.

Examples of fluoropolymers include, but are not limited to, polytetrafluoroethylene (PTFE), perfluoroalkoxy polymer (PFA), fluorinated ethylene-propylene (FEP), polyethylenetetrafluoroethylene (ETFE), polyvinylfluoride (PVF), polyethylenechlorotrifluoroethylene (ECTFE), polyvinylidene fluoride (PVDF), polychlorotrifluoroethylene (PCTFE), and perfluoropolyether (PFPE).

Some examples of commercial fluoropolymers include the following: TEFLON (available from of DuPont), HYFLON (available from Solvay Solexis S.p.A.), TEFZEL (available from DuPont), FLUON (available from Asahi Glass Company), TEDLAR (available from of DuPont), HALAR (available from Solvay Solexis S.p.A.), KYNAR (available from Arkema, Inc.), SOLEF (available from Solvay Solexis S.p.A.), HYLAR (available from Solvay Solexis S.p.A.), KALREZ (available from of DuPont), TECNOFLON (available from Solvay Solexis S.p.A.), VITON (available from of DuPont), FOMBLIN (available from Solvay Solexis S.p.A.), GALDEN (available from Solvay Solexis S.p.A.), and DYNAMAR (available from Dyneon).

In one embodiment, the processing additive is a polyethylene glycol. In a further embodiment, the polyethylene glycol has a number average molecular weight less than 20,000 g/mole. In another embodiment, the polyethylene glycol has a number average molecular weight from 300 to 100,000 g/mole.

In one embodiment, the polyethylene glycol is selected from linear polyethylene glycols, branched polyethylene glycols, star polyethylene glycols, comb polyethylene glycols, or combinations thereof.

Some commercial examples of polyethylene glycols include the following: CARBOWAX polyethylene glycols (available from The Dow Chemical Company), FORTRANS (available from Beaufour Ipsen Pharma), and MACROGOL (available from Sanyo Chemical Industries).

An inventive composition may comprise a combination of two or more embodiments as described herein.

### Ethylene-Based Polymers

In one embodiment, the ethylene-based polymer has a density greater than, or equal to, 0.910 g/cc, preferably greater than, or equal to, 0.925 g/cc, and more preferably greater than, or equal to, 0.940 g/cc.

In one embodiment, the ethylene-based polymer has a density less than, or equal to, 0.965 g/cc, preferably less than, or equal to, 0.960 g/cc, and more preferably less than, or equal to, 0.955 g/cc.

In another embodiment, the ethylene-based polymer has a high flow melt index, I₂₁ (190° C., 21.6 kg weight, 10 minutes, ASTM 1238), greater than, or equal to, 1, preferably greater than, or equal to, 2, and more preferably greater than, or equal to, 4 g/10 min.

In another embodiment, the ethylene-based polymer has a high flow melt index, I₂₁ (190° C., 21.6 kg weight, 10 minutes, ASTM 1238), less than, or equal to, 100, preferably less than, or equal to, 50, preferably less than, or equal to, 20, and more preferably less than, or equal to, 10 g/10 min.

In one embodiment, the ethylene-based polymer has a high load melt index (I21) from 1 to 100 g/10 min, preferably from 1 to 50 g/10 min, preferably from 2 to 20 g/10 min, and more preferably from 4 to 10 g/10 min.

In one embodiment, the ethylene-based polymer has an I₂₁/I₂ ratio from 50 to 150, preferably from 75 to 120, and more preferably from 80 to 110.

In one embodiment, the ethylene-based polymer is an ethylene/α-olefin interpolymer. In a further embodiment, the α-olefin is a C3-C20 α-olefin, preferably a C4-C10 α-olefin, and more preferably a C6-C8 α-olefin. Preferred α-olefins include 1-butene, 1-hexene, and 1-octene. Especially preferred α-olefins include 1-hexene and 1-octene, and most preferably 1-hexene. Preferred copolymers include ethylene/butene-1 (EB) copolymers, ethylene/hexene-1 (EH) copolymers and ethylene/octene-1 (EO) copolymers, more preferably ethylene/hexene-1 (EH) copolymers and ethylene/octene-1 (EO) copolymers.

In one embodiment, the ethylene-based polymer is an ethylene/hexene-1 (EH) copolymer.

In one embodiment, the ethylene-based polymer is an ethylene/octene-1 (EO) copolymer.

In one embodiment, the ethylene-based polymer is an in-situ reactor blend.

In one embodiment, the ethylene-based polymer is a post reactor blend.

In a preferred embodiment, the ethylene-based polymer is a linear ethylene-based interpolymer, and preferably a heterogeneously branched linear ethylene-based interpolymer. The term “linear ethylene-based interpolymer,” as used herein, refers to an interpolymer that lacks long-chain branching, or lacks measurable amounts of long chain branching, as determined by techniques known in the art, such as NMR spectroscopy (for example 1C NMR as described by Randall, Rev. Macromol. Chem. Phys., C29 (2&3), 1989, pp. 285-293, incorporated herein by reference). Some examples of long-chain branched interpolymers are described in U.S. Pat. Nos. 5,272,236 and 5,278,272. As known in the art, the heterogeneously branched linear and homogeneously branched linear interpolymers have short chain branching due to the incorporation of comonomer into the growing polymer chain.

Heterogeneously branched interpolymers have a branching distribution, in which the polymer molecules do not have the same comonomer-to-ethylene ratio. For example, heterogeneously branched LLDPE polymers typically have a distribution of branching, including a highly branched portion (similar to a very low density polyethylene), a medium branched portion (similar to a medium branched polyethylene) and an essentially linear portion (similar to linear homopolymer polyethylene). These linear interpolymers lack long chain branching, or measurable amounts of long chain branching, as discussed above.

The terms “homogeneous” and “homogeneously-branched” are used in reference to an ethylene polymer (or interpolymer), in which the comonomer is randomly distributed within a given polymer molecule, and all of the polymer molecules have the same or substantially the same comonomer-to-ethylene ratio.

Suitable ethylene-based polymers include, but are not limited to, CONTINUUM Bimodal Polyethylene Resins available from The Dow Chemical Company.

The ethylene-based polymer may comprise a combination of two or more embodiments as described herein.

### Additives

A composition may comprise one or more additives. Suitable additives include, but are not limited to, fillers, processing aids, acid neutralizers, UV stabilizers, antioxidants, process stabilizers, metal de-activators, lubricants, anti-blocking agents, antistatic agents, antimicrobial agents, chemical blowing agents, coupling agents, nucleating agents, additives to improve oxidative or chlorine resistance, pigments or colorants. A typical additive package may contain a mixture of phenolic type and phosphite type antioxidants.

### DEFINITIONS

The term “composition,” as used herein, includes a mixture of materials, which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure) and the term interpolymer as defined hereinafter.

The term “interpolymer,” as used herein, refers to polymers prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to an interpolymer that comprises at least a majority weight percent polymerized olefin (for example, ethylene or propylene), based on the weight of interpolymer, and optionally one or more additional comonomers.

The term “ethylene-based polymer,” as used herein, refers to an interpolymer that comprises at least a majority weight percent polymerized ethylene (based on the weight of interpolymer), and optionally one or more additional comonomers.

The term “ethylene-based interpolymer,” as used herein, refers to an interpolymer that comprises at least a majority weight percent polymerized ethylene (based on the weight of interpolymer), and one or more additional comonomers.

The term “ethylene/α-olefin interpolymer,” as used herein, refers to an ethylene-based interpolymer that comprises at least a majority weight percent polymerized ethylene (based on the weight of interpolymer), an α-olefin, and optionally, one or more additional comonomers.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “propylene-based polymer,” as used herein, refers to an interpolymer that comprises at least a majority weight percent polymerized propylene (based on the weight of interpolymer), and optionally one or more additional comonomers.

The term “propylene-based interpolymer,” as used herein, refers to an interpolymer that comprises at least a majority weight percent polymerized propylene (based on the weight of interpolymer), and one or more additional comonomers.

The term, “propylene/α-olefin interpolymer,” as used herein, refers to an interpolymer that comprises, in polymerized form, a majority amount of propylene monomer (based on the weight of the interpolymer), and at least one α-olefin.

The term, “propylene/α-olefin copolymer,” as used herein, refers to a copolymer that comprises, in polymerized form, a majority amount of propylene monomer (based on the weight of the copolymer), and an α-olefin, as the only two monomer types.

The term, “propylene/ethylene interpolymer,” as used herein, refers to an interpolymer that comprises, in polymerized form, a majority amount of propylene monomer (based on the weight of the interpolymer), and ethylene.

The term, “propylene/ethylene copolymer,” as used herein, refers to a copolymer that comprises, in polymerized form, a majority amount of propylene monomer (based on the weight of the copolymer), and ethylene, as the only two monomer types.

The term “in-situ reactor blend,” as used herein, refers to a mixture of two or more polymers, prepared by polymerizing at least one polymer in the presence of at least one other polymer.

The term “post-reactor blend,” as used herein, refers to a mixture of two or more polymers, each polymerized in a separate reactor.

The terms “comprising”, “including”, “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### Test Methods

Density was measured via ASTM D-792-08. Compression molded samples were made in accordance with ASTM D-4703-00, procedure C, test within one hour.

### Melt Index

Melt index (I₂) of an ethylene-based polymer is measured in accordance with ASTM D-1238-04, condition 190° C./2.16 kg/10 min Melt index (I₅) of an ethylene-based polymer is measured in accordance with ASTM D-1238-04, condition 190° C./5.0 kg/10 min. Melt index (I₁₀) of an ethylene-based polymer is measured in accordance with ASTM D-1238-04, condition 190° C./10.0 kg/10 min High load melt index (I₂₁) of an ethylene-based polymer is measured in accordance with ASTM D-1238-04, condition 190° C./21.6 kg/10 min The melt flow rate (MFR) of a propylene-based polymer is measured in accordance with ASTM D-1238-04, condition 230° C./2.16 kg/10 min.

### Gel Permeation Chromatography (GPC)

Polymer molecular weight can be characterized by high temperature, triple detector gel permeation chromatography (3D-GPC). The chromatographic system consists of a Waters (Milford, Mass.), 150° C. high temperature chromatograph, equipped with a Precision Detectors (Amherst, Mass.) 2-angle laser light scattering detector, Model 2040, and a 4-capillary differential viscometer detector, Model 150R, from Viscotek (Houston, Tex.). The “15° angle” of the light scattering detector is used for calculation purposes. Concentration is measured via an infra-red detector (IR4) from PolymerChar (Valencia, Spain).

Data collection is performed using Viscotek TriSEC software version 3 and a 4-channel Viscotek Data Manager DM400. The carrier solvent is 1,2,4-trichloro-benzene (TCB). The system is equipped with an on-line solvent degas device from Polymer Laboratories. The carousel compartment and the column compartment are operated at 150° C. The columns are four Polymer Laboratories Mixed-A 30 cm, 20 micron columns. The polymer solutions of the reference and inventive samples are prepared in TCB. The sample solutions are prepared at a concentration of “0.1 gram of polymer in 50 ml of solvent.” The chromatographic solvent (TCB) and the sample preparation solvent (TCB) contains 200 ppm of butylated hydroxytoluene (BHT). Both solvent sources are nitrogen sparged. The polyethylene samples are stirred gently at 160° C. for four hours. The injection volume is 200 μl, and the flow rate is 1.0 ml/minute. The preferred column set is of 20 micron particle size and “mixed” porosity gel to adequately separate the highest molecular weight fractions appropriate to the claims.

Calibration of the GPC column set is performed with 21 narrow molecular weight distribution polystyrene standards. The molecular weights of the standards range from 580 to 8,400,000 g/mol, and are arranged in six “cocktail” mixtures, with at least a decade of separation between individual molecular weights.

The polystyrene standard peak molecular weights are converted to polyethylene molecular weights using the following equation (as described in Williams and Ward, J. Polym. Sci., Polym. Let., 6, 621 (1968)):

Mpolyethylene=A×(Mpolystyrene)^{B} (1),

where M is the molecular weight, A has a cited value of 0.4316, and B is equal to 1.0.

An alternative value of A, herein referred to as “q” or as a “q factor”, is experimentally determined to be around 0.39 (Eqn. 1 above). The best estimate of “q” is determined using the predetermined weight average molecular weight of a broad linear polyethylene homopolymer (Mw ˜115,000 g/mol, Mw/Mn ˜3.0). Said weight average molecular weight is obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Page 113-136, Oxford, N.Y. (1987)). The response factor, KLS, of the laser detector is determined using the certificated value for the weight average molecular weight of NIST 1475 (52,000 g/mol). The method for obtaining the alternative “q factor” is described in more detail below.

A first order polynomial is used to fit the respective polyethylene-equivalent calibration points obtained from Equation 1 to their observed elution volumes. The actual polynomial fit is obtained so as to relate the logarithm of polyethylene equivalent molecular weights to the observed elution volumes (and associated powers) for each polystyrene standard.

The total plate count of the GPC column set is performed with EICOSANE (prepared at 0.04 g in 50 milliliters of TCB, and dissolved for 20 minutes with gentle agitation). The plate count and symmetry are measured on a 200 microliter injection according to the following equations:

PlateCount=5.54*(RV at Peak Maximum/(Peak width at ½ height))² (2),

where RV is the retention volume in milliliters, and the peak width is in milliliters.

Symmetry=(Rear peak width at one tenth height−RV at Peak maximum)/(RV at Peak Maximum−Front peak width at one tenth height) (3),

where RV is the retention volume in milliliters, and the peak width is in milliliters.

The plate count for the chromatographic system (based on EICOSANE as discussed previously) should be greater than 22,000, and symmetry should be between 1.00 and 1.12.

The Systematic Approach for the determination of each detector offset is implemented in a manner consistent with that published by Balke, Mourey (Mourey and Balke, Chromatography Polym. Chpt 12, (1992)) (Balke, Thitiratsakul, Lew, Cheung, Mourey, Chromatography Polym. Chpt 13, (1992)), using data obtained from the three detectors, while analyzing the broad linear polyethylene homopolymer (115,000 g/mol) and the narrow polystyrene standards. The Systematic Approach is used to optimize each detector offset to give molecular weight results as close as possible to those observed using the conventional GPC method. The overall injected concentration, used for the determinations of the molecular weight and intrinsic viscosity, is obtained from the sample infra-red area, and the infra-red detector calibration (or mass constant) from the linear polyethylene homopolymer of 115,000 g/mol. The chromatographic concentrations were assumed low enough to eliminate addressing 2nd Virial coefficient effects (concentration effects on molecular weight).

The calculations of Mn, Mw, Mz and Mz+1, based on GPC results using the IR4 detector and the narrow standards calibration, are determined from the following equations:

$$\begin{matrix}\overline{Mn} = \frac{{\sum }^{i} {IR}_{i}}{{\sum }^{i} ( \frac{{IR}_{i}}{{M}_{PE , i}} )} , & ( 4 ) \\ \overline{Mw} = \frac{{\sum }^{i} ( {IR}_{i} * {M}_{PE , i} )}{{\sum }^{i} {IR}_{i}} , & ( 5 ) \\ \overline{Mz} = \frac{{\sum }^{i} ( {IR}_{i} * {M}_{PE , i}^{2} )}{{\sum }^{i} ( {IR}_{i} * {M}_{PE , i} )} , & ( 6 ) \\ \overline{Mz + 1} = \frac{{\sum }^{i} ( {IR}_{i} * {M}_{PE , i}^{3} )}{{\sum }^{i} ( {IR}_{i} * {M}_{PE , i}^{2} )} . & ( 7 )\end{matrix}$$

Where IRᵢ and M_{PE,i} are the IR baseline corrected response and conventional calibrated polyethylene molecular weight for the ith slice of the IR response, elution volume paired data set. The Equations 4, 5, 6, and 7 are calculated from polymers prepared in solutions of TCB.

The “q-factor,” described previously, is obtained by adjusting “q” or A in Equation 1, until Mw, the weight average molecular weight, calculated using Equation 5, and the corresponding retention volume polynomial, agreed with the independently determined value of Mw, obtained in accordance with Zimm for the broad linear polyethylene homopolymer (115,000 g/mol).

The weight percent of polymer fraction with molecular weights>10⁶ g/mol, is calculated by summing the baseline corrected IR responses, IRᵢ, for the elution volume slices whose calibrated molecular weights, M_{PE,i}, are greater than 10⁶ g/mole, and expressing this partial sum as a fraction of the sum of all the baseline corrected IR responses from all elution volume slices. A similar method is used to calculate the weight percentage of polymer fractions with absolute molecular weights>10⁶ and 10⁷ g/mol. The absolute molecular weight is calculated use the 15° laser light scattering signal, and the IR concentration detector, M_{PE,I, abs}=KLS*(LSᵢ)/(IRᵢ), using the same KLS calibration constant as in Equation 8. The paired data set of the ith slice of the IR response and LS response is adjusted using the determined off-set as discussed in the Systematic Approach.

In addition to the above calculations, a set of alternative Mw, Mz and MZ+1 [Mn(abs), Mw (abs), Mz (abs), and MZ+1 (abs)] values were also calculated with the method proposed by Yau and Gillespie, (Yau and Gillespie, Polymer, 42, 8947-8958 (2001)), and determined from the following equations:

$$\begin{matrix}\overline{Mn} ( abs ) = {K}_{LS} * \frac{{\sum }^{i} ( {IR}_{i} )}{{\sum }^{i} ( {IR}_{i} / {LS}_{i} )} , & ( 8 ) \\ \overline{Mw} ( abs ) = {K}_{LS} * \frac{{\sum }^{i} ( {LS}_{i} )}{{\sum }^{i} ( {IR}_{i} )} , & ( 9 )\end{matrix}$$

where, KLS=LS−MW calibration constant. As explained before, the response factor, KLS, of the laser detector is determined using the certificated value for the weight average molecular weight of NIST 1475 (52,000 g/mol).

$$\begin{matrix}\overline{Mz} ( abs ) = {K}_{LS} * \frac{{\sum }^{i} [ {IR}_{i} * {( {LS}_{i} / {IR}_{i} )}^{2} ]}{{\sum }^{i} [ {IR}_{i} * ( {LS}_{i} / {IR}_{i} ) ]} , and & ( 10 ) \\ \overline{Mz + 1} ( abs ) = {K}_{LS} * \frac{{\sum }^{i} [ {IR}_{i} * {( {LS}_{i} / {IR}_{i} )}^{3} ]}{{\sum }^{i} [ {IR}_{i} * {( {LS}_{i} / {IR}_{i} )}^{2} ]} , & ( 11 )\end{matrix}$$

where LSᵢ is the 15 degree LS signal and the LS detector alignment is as described previously.

In order to monitor the deviations over time, which may contain an elution component (caused by chromatographic changes) and a flow rate component (caused by pump changes), a late eluting narrow peak is generally used as a “flow rate marker peak.” A flow rate marker is therefore established based on a decane flow marker, dissolved in the eluting sample prepared in TCB. This flow rate marker is used to linearly correct the flow rate for all samples by alignment of the decane peaks.

### Experimental

### Dissolution of Processing Additive (For Examples 2 and 4))

A glass bottle (16 oz) with cap was placed on a stirring plate. A magnetic stirring bar was placed inside the bottle.

Acetone (400 g) was carefully poured into the glass bottle.

A fluoropolymer-based processing additive (10 g, DYNAMAR FX-5911, available from Dyneon) was added into the bottle slowly, with the stirring, to prevent caking of the processing additive at the bottom of the bottle. The bottle was capped tightly to prevent the acetone from evaporating.

When all of the processing additive was dissolved, an additional amount of the processing additive (10 g) was added slowly into the bottle. With the cap on, stirring was continued, until all processing additive dissolved.

Additional processing additive (5-10 grams at a time) was added, until the solubility limit of the processing additive was reached, at room temperature, and small amount of undissolved additive remain at the bottom of the bottle.

In this case, a total of 75 grams of the processing additive was added. An additional 275 grams of acetone was added to ensure all solids were dissolved, and to form the final solution (PA solution). The weight percentage of the processing additive is calculated as follows: 75/(400+275+75)=10 wt %.

### EXAMPLE

### Die Gap Treatment (For Examples 2 and 4)

The die may be either cold or warm for this procedure. This procedure should be performed in a well ventilated area, without any potential ignition source. For best results, it is recommended that the pin is removed from the die assembly, and both sides of the die gap are thoroughly polished to remove residual polymer buildup and metal oxidation, before the PA solution is applied. In cases where the die gap is large enough to allow thorough cleaning, disassembly of the die may not be required.

The die and pin were cleaned with a 3M Scotch-Brite hand pad, or equivalent, to remove residual polymer and metal oxidation.

The pin and the shell of the die gap assembly were thoroughly sprayed with the PA solution, using a spray bottle with an adjustable spray nozzle, in a well ventilated area. This step was repeated, if necessary, to ensure full coverage (used proper safety procedures for use of inflammable materials).

The die was reassembled.

The above treatment may be done with the die assembled, by spraying the PA solution directly into the die gap, after thoroughly cleaning the die gap. The treatment may also be done on a warm, or hot, die, if proper precautions are taken to ensure the safety of the operator.

The extrusion line can be put into production immediately following the treatment. The PA solution should be stored according to local practices, policies, and procedures.

### Pipe Extrusion

### Examples 1 and 2

Pipe was extruded on an AMERICAN MAPLAN (60 mm barrel, 30/1 L/D) extrusion line, equipped with a pipe die for the manufacture of nominally four inch IPS (iron pipe size), SDR 11 pipe. The resin (ethylene/1-hexene copolymer plus additives, with a final density from 0.947-0.951 g/cc (1 cc=1 cm³), and final I₂₁ from 6-8 g/10 min, available from The Dow Chemical Company under the tradename of CONTINUUM DGDA-2490 NT) was blended with a carbon black master batch using a MAGUIRE feeder/blender system, before the pipe extrusion. The carbon black master batch contained 35 weight percent of carbon black in a LLDPE carrier resin.

The pipe extruder temperature profile and process conditions are given in the example below. A vacuum sizing method was employed to dimensionally size the pipe. An additional cooling water tank was employed to completely solidify the pipe. The cooling water temperature was approximately 55° F. A variable speed puller was run under constant speed conditions for the pipe size produced.

Typical pipe extrusion conditions are as follows.

Barrel Temperature: 410° F.

Die Temperature: 420° F.

Melt Temperature: 405° F.

Amp Load: 55%

Head Pressure: 2080 psi

Output Rate: 515 lbs/hr

Pipe O.D.: 4 inch IPS

Pipe Size: SDR 11

### Example #1 (Comparative)

### Pipe Extrusion Without Application of “PA Solution” on Die Gap

At the start up of the pipe extrusion line, some melt fracture, and a number of die lines in the pipe direction, were observed on the pipe. The pipe surface had a matt finish appearance. As the process additive in the resin gradually coated the die gap, during the extrusion, the melt fracture appearance and the number of die lines gradually decreased. After 30 minutes of pipe extrusion, about 20% of the die lines were replaced with bands having a smooth and shining surface. After one hour, about 45% of the pipe surfaces (outer surface and inner surface) looked smooth and shining. Two hours later, about 60% of the pipe surfaces looked smooth and shining Four hours later, about 85% of the pipe surfaces had no die lines. Six hours later, both the outer and inner pipe surfaces looked smooth and shining, as melt fracture was no longer observed and die lines were no longer observed. Within six hours, a large amount of scrape pipe (about 3,090 lbs) was generated.

### Example #2 (Inventive)

### Pipe Extrusion With Application of “PA Solution” on Die Gap

Three minutes after the cold die gap was sprayed with the PA solution (10 wt % DYNAMAR FX-5911 in acetone), the pipe extrusion line was started. The hot polymer melt looked smooth and shining, immediately after exiting the die, and the pipe produced had a very good surface appearance (both outer surface and inner surface), with no melt fracture or die lines observed. Pipe was produced for another three hours. No scrap pipe was produced.

### Pipe Extrusion

### Examples 3 and 4

Pipe was extruded on an AMERICAN MAPLAN (60 mm barrel, 30/1 L/D) extrusion line, equipped with a pipe die for the manufacture of nominally four inch IPS (iron pipe size), SDR 11 pipe. The resin (ethylene/1-hexene copolymer plus additives, with a final density from 0.947-0.951 g/cc (1 cc=1 cm³), and final I₂₁ from 4-7 g/10 min, available from The Dow Chemical Company under the tradename of CONTINUUM DGDA-2492 NT) was blended with a carbon black master batch using a MAGUIRE feeder/blender system, before the pipe extrusion. The carbon black master batch contained 35 weight percent of carbon black in a LLDPE carrier resin.

The pipe extruder temperature profile and process conditions are given in the example below. A vacuum sizing method was employed to dimensionally size the pipe. An additional cooling water tank was employed to completely solidify the pipe. The cooling water temperature was approximately 55° F. A variable speed puller was run under constant speed conditions for the pipe size produced.

Typical pipe extrusion conditions are as follows.

Barrel Temperature: 410° F.

Die Temperature: 420° F.

Melt Temperature: 411° F.

Amp Load: 58%

Head Pressure: 2350 psi

Output Rate: 502 lbs/hr

Pipe O.D.: 4 inch IPS

Pipe Size: SDR 11

### Example #3 (Comparative)

### Pipe Extrusion Without Application of “PA Solution” on Die Gap

At the start up of the pipe extrusion line, some melt fracture, and a number of die lines in the pipe direction, were observed on the pipe. The pipe surface had a matt finish appearance. As the process additive in the resin gradually coated the die gap, during the extrusion, the melt fracture appearance and the number of die lines gradually decreased. After 30 minutes of pipe extrusion, about 20% of the die lines were replaced with bands having a smooth and shining surface. After one hour, about 35% of the pipe surfaces (outer surface and inner surface) looked smooth and shining Two hours later, about 50% of the pipe surfaces looked smooth and shining Four hours later, about 70% of the pipe surfaces had no die lines. Six hours later, about 85% of the pipe surfaces had no die lines. Ten hours later, both the outer and inner pipe surfaces looked smooth and shining, as melt fracture was no longer observed and die lines were no longer observed. Within ten hours, a large amount of scrape pipe (about 5,020 lbs) was generated.

### Example 4 (Inventive)

### Pipe Extrusion with Application of “PA Solution” on Die Gap

Three minutes after the cold die gap was sprayed with the PA solution (10 wt % DYNAMAR FX-5911 in acetone), the pipe extrusion line was started. The hot polymer melt looked smooth and shining, immediately after exiting the die, and the pipe produced had a very good surface appearance (both outer surface and inner surface), with no melt fracture or die lines observed. Pipe was produced for another four hours. No scrap pipe was produced.

Although the invention has been described in considerable detail in the preceding examples, this detail is for the purpose of illustration, and is not to be construed as a limitation on the invention, as described in the following claims.

1. A process for extruding a composition, comprising at least one polymer, through a die, comprising applying at least one processing additive (PA) onto at least one surface of the die, and extruding the composition through the die, and wherein the processing additive is applied to the die as a solution.

2. The process of claim 1, wherein the processing additive is dissolved in a solvent or solvent mixture.

3. The process of claim 1, wherein the processing additive is dissolved in a solvent or solvent mixture that has a maximum boiling point less than 100° C. (at ambient atmosphere).

4. The process of claim 1, wherein the composition is extruded through the die in less than 10 minutes, after the processing additive is applied to the die.

5. The process of claim 1, wherein the processing additive is dissolved in a solvent at a concentration of 50 weight percent or less, based on the weight of the solution.

6. The process of claim 1, wherein the processing additive is dissolved in a solvent at a concentration from 1 to 50 weight percent, based on the weight of the solution.

7. The process of claim 1, wherein the solvent is selected from acetone, methyl ethyl ketone, isopropyl alcohol, or combinations thereof.

8. The process of claim 1, wherein the processing additive is selected from a fluoropolymer, a polyethylene glycol, or a combination thereof.

9. The process of claim 1, wherein the polymer is an olefin-based polymer.

10. The process of claim 9, wherein the olefin-based polymer is an ethylene-based polymer.

11. The process of claim 9, wherein the olefin-based polymer is a propylene-based polymer.

12. An article comprising at least one component formed from the process of claim 1.

13. A composition comprising at least one processing additive (PA), and a solvent or a solvent mixture.

14. The composition of claim 13, wherein the processing additive is selected from a fluoropolymer, a polyethylene glycol, or a combination thereof.

15. The composition of claim 13, wherein the solvent is selected from acetone, methyl ethyl ketone, or isopropyl alcohol, or wherein the solvent mixture comprises at least one solvent selected from acetone, methyl ethyl ketone, or isopropyl alcohol.
